(19) United States
(12) Patent Application Publication
(10) Pub. No.: US 2012/0281128 A1
(43) Pub. Date: Nov. 8, 2012

(54) TAILORING AUDIO VIDEO OUTPUT FOR VIEWER POSITION AND NEEDS

(75) Inventor: Peter Shintani, San Diego, CA (US)

(73) Assignee: SONY CORPORATION

(21) Appl. No.: 13/101,481

(22) Filed: May 5, 2011

(51) Int. Cl. H04N 5/225

(52) U.S. Cl. 348/333.01; 348/E05.133

(57) ABSTRACT

An assembly that can determine position of a viewer of an audio video device and direct changes in audio and video output in response to azimuth, elevation, and range of the viewer in relation to the assembly. The assembly can also utilize facial recognition to direct changes in audio and video output in response to preprogrammed special needs of specific viewers.

### FIELD OF THE INVENTION

The present application relates generally to tailoring the audio and/or video output of an AV device for viewer position relative to the AV device and/or viewer special needs.

### BACKGROUND OF THE INVENTION

For the hearing impaired, or non-native language users, closed captioning on audio video (AV) devices such as TVs is helpful. As recognized herein, with advancing technology other means are now available for improving the audibility and/or viewability of an AV device.

### SUMMARY OF THE INVENTION

An assembly includes a video display, at least one audio speaker, and a processor controlling the display and speaker to output audio video (AV) content to a viewer of the assembly. The assembly also includes a camera that can input an image of the viewer to the processor, which can determine a viewer position including at least an azimuth of the viewer relative to the assembly. The processor can adjust at least some of the AV content responsive to the position of the viewer. In some embodiments the processor can further correlate the viewer to physical audible and/or visual needs information and can adjust at least some of the AV content responsive to the physical audible and/or visual needs of the viewer.

The position can further include elevation and range of the viewer relative to the assembly. The processor can adjust both the audio and the video elements based on the viewer's position. The audio elements that can be adjusted include volume and direction of audio and the video elements can include a color setting of the display and the size of an onscreen image responsive to the position of the viewer.

The processor can further adjust the audio and video elements in response to special needs of the viewer. Audible impairment of a viewer can lead to the processor adjusting the frequency of audio output by the speaker and/or volume of audio output by the speaker. In the case of visual impairment of a viewer, the processor can alter a size of an onscreen image and/or a color setting of the display.

In another aspect, a method includes receiving viewer location information from a camera. The location information represents a relative position of the viewer with respect to an audio video display apparatus including a video display and at least one audio speaker. Responsive to the viewer location information, the method includes establishing a display parameter of the video display and/or a display parameter of the speaker.

In another aspect, an assembly has a video display, at least one audio speaker, and a processor controlling the display and speaker to output audio video (AV) content to a viewer of the assembly. A camera inputs an image of the viewer to the processor, and the processor correlates the viewer to physical audible and/or visual needs of the viewer. The processor adjusts display of at least some of the AV content responsive to the physical audible and/or visual needs of the viewer.

Example implementation details of present principles are set forth in the description below, in which like numerals refer to like parts, and in which:

### BRIEF DESCRIPTION OF THE DRAWINGS

FIG. 1 is a block diagram of an example AV device;

FIG. 2 is a flow of example logic for receiving specific viewer special need information;

FIG. 3 is a flow chart of example logic for tailoring the output of the AV device to the viewer's location relative to the device; and

FIG. 4 is a flow chart of example logic for tailoring the output of the AV device to the viewer's special needs.

### DETAILED DESCRIPTION OF THE PREFERRED EMBODIMENT

Terms of direction are relative to the TV display when it is disposed upright in a vertical position.

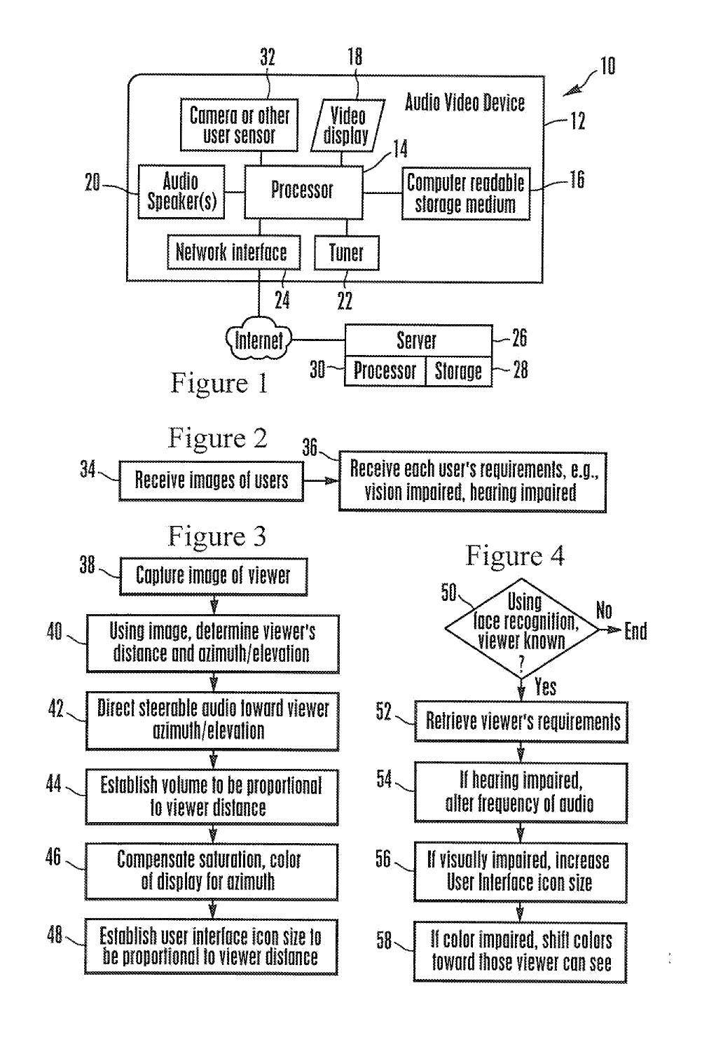

Referring initially to FIG. 1, a non-limiting, exemplary system generally designated 10 is shown. The system 10 includes a audio video device 12 such as a TV that has a processor 14 accessing one or more non-transitory computer readable data storage media 16 such as, but not limited to, RAM-based storage (e.g., a chip implementing dynamic random access memory (DRAM)) or flash memory or disk-based-storage to execute the logic described below, which may be stored on the media 16 as lines of executable code.

As shown in FIG. 1, the audio video device 12 may also have one or more output devices such as a display 18 for presenting video and still images and audio speakers 20 for presenting audio. The audio video device 12 may also have one or more input devices capable of receiving input from a user, such as a remote control device. However, it is to be understood that other input devices may also be present on the audio video device 12, such as a personal computer “mouse” or a mobile telephone touch screen. When the AV device 12 is embodied as a TV, it typically includes a TV tuner 22 communicating with the processor 14.

Additionally, the audio video device 12 may include a network interface 24 such as a wired or wireless modem or wireless telephony transceiver that may communicate with the processor 14 to provide connectivity to a wide area network such as the internet. It is to be understood that the audio video device 12 may also include a power supply (not shown) to provide voltage to the audio video device 12, such as a battery or an AC/DC power supply.

Still in reference to FIG. 1, a remote server 26 is also shown, which the AV device 12 may access over the Internet or other network. The server 26 has at least one non-transitory computer readable: data storage medium 28 such as, but not limited to, RAM-based storage (e.g., a chip implementing dynamic random access memory (DRAM)) or flash memory or disk-based-storage. The storage medium 28 may store profile information relating to at least one user, where the profile information may include special needs such as “vision impaired”, “hearing impaired”, “color blind for blue (or other color)”, and so on. Additionally, the remote server 26 may also include a processor 30 capable of processing requests and/or commands received from the audio video device 12 in accordance with present principles.

FIG. 1 also shows that the AV device 12 can include a user presence sensor. Using an already available “presence” sensor in an AV device 12 is the most economical, i.e., re-use the already present hardware. If multiple speakers are already in the AV device 12, the speakers can be driven via phasing system to allow beam forming. Alternatively, the above processing may be done via an external adapter. Such an adapter uses its own camera system 32 or plug in camera to detect the viewer, and it then sends picture control data to the AV device 12, and also reproduce the sound for an external directional speaker system. However, in the embodiment shown and as set forth further below, using the camera 32 or other device capable of detecting viewer location relative to the AV device 12, the processor 14 of the AV device. 12 can determine the location of the viewer relative to the AV device 12 in both the azimuthal and elevation dimensions, as well as determine the distance of the viewer from the AV device 12, for purposes to be shortly disclosed.

Moreover, when the viewer is imaged the processor 14 can use face recognition techniques to compare the image with a database of images to determine if the viewer is in the database and if so, can retrieve the viewer's special needs profile. As discussed further below, the processor 14 tailors the audio and video for the particular user. If multiple users are registered, the users can be assigned a priority so that the image recognition system tailors the audio and video to be most appropriate for the location of the user who is assigned the highest priority.

Moving in reference to FIG. 2, logic for receiving the special need information specific to a viewer begins with capturing an image of the viewer with the camera 32 at block 34. The processor 14 may send the captured viewer image to the server 26 via wide area network, i.e. the Internet and/or it may retain the images locally. If plural viewers are present, the camera 32 can capture each viewer's image and the processor 14 can send plural images to the server 26.

The processor 30 of the server 26 receives the viewer image(s) and, using a facial recognition engine, matches the image with images and data previously stored on the storage medium 28 and downloaded from the server or input by the users. If an identity match between the image(s) and previously stored data and images exists, then the processor 30 can determine the viewer requirements, e.g. vision impaired, hearing impaired, etc. stored on the storage medium 28. The AV device's processor 14 can receive the determined viewer requirements at block 36. In an alternative implementation, the viewer images and requirement information may be stored on the AV device's storage medium 16 and shared with the processor 30 of the server 26 via wide area network.

A viewer may manually input his identity, e.g., by selecting his identity or name from a list presented on the display 18 via an input device such as remote control or keyboard or by inputting the name and correlating it to one of the stored viewer images. In such an embodiment, the viewer requirements could be stored on the AV device's storage medium 16 rather than, or in addition to, the requirements being stored on the storage medium 28 of the server 26.

Now referring to FIG. 3, the logic for adjusting AV output based on viewer position begins with a viewer presence senor, i.e. camera 32. An image of the viewer is captured with the camera 32 at block 38 and sent to the processor 14 for determination of viewer position. Using the image, the viewer position is determined at block 40, the position being at least viewer azimuth, but preferably also range and elevation with respect to the AV device 12.

The processor 14 can use position information to instruct the audio output 20 to direct the steerable audio toward the viewer azimuth and elevation at block 42. For example, highly directional audio speaker systems may be available, which could use an array or other means to aim the sound at one location. That “aimed” sound could also be the same or separately equalized for a particular viewer. The processor 14 can also instruct the audio output 20 to alter the volume so that it is directly proportional to distance between viewer and AV device 12 at block 44, with higher decibel levels being used for relatively distant viewers and lower decibel levels being used for relatively close viewers. The above process can be repeated every few seconds so that if viewers change location relative to the TV the sound direction and volume changes accordingly.

In addition to audio components of the AV device 12 being altered, the video components may be altered to provide optimal presentation for the viewer positioned at a specific azimuth, elevation, and range. The processor 14 may compensate saturation and/or the color of the display 18 for the determined azimuth at block 46. The saturation and color of a display, including but not limited to the display 18, is sometimes affected by the viewing angle, and hence this may also be compensated for. This may also be an advantage to a stereoscopic display. The processor 14 may also establish an onscreen icon size to be proportional to the determined distance between the AV device 12 and the viewer at block 48.

Referring to FIG. 4, logic for adjusting AV output based on viewer special needs begins with decision diamond 50, in which it is determined by the processor 30 using facial recognition if the viewer is known. Another option for viewer identification is viewer input via input device, i.e. remote control. If the viewer is not recognized, the logic carried out by the processor 14 ends and no audio or video output is altered. Conversely, if the viewer is recognized, the viewer's special needs requirements are retrieved from either the AV storage medium 16 or the server storage medium 28 at block 52.

If the viewer's special needs requirements indicate that the viewer is hearing impaired, the processor 14 may instruct the audio speakers to alter the frequency and or volume of the audio at block 54. For a hearing impaired viewer, the sound's frequency response can be altered best to accommodate the viewer's particular hearing disorder, i.e., typically loss of high frequency response. The volume may be increased for a viewer with hearing loss, or it may be decreased for a viewer with sensitive hearing. The frequency response may be adjusted to compensate for an off-axis position of the viewer by, e.g., raising frequency output by a speaker that is more distant from the viewer relative to the frequency output by a closer speaker.

If two viewers with opposite special needs, i.e. one with hearing loss and one with sensitive hearing, are present, the processor 14 may adjust the AV component, i.e. audio volume, to suit the viewer who was recognized first. The processor 14 may also make adjustments to suit the viewer who requires the most help or the least help.

In the case of a visually impaired viewer, as indicated by the special needs information, the onscreen icon size may be increased at block 56. The increase in size may apply to a person who is nearsighted and cannot clearly discern distant objects. The logic concludes at block 58, in which the colors of the display 18 may be shifted towards those that the viewer can see, in the case that the viewer cannot see specific colors, to make the images more discernable.

Note that the identity of the user can be used to vary the access to the UI and to also limit the functionality of the UI. For example, based on a recognized user being a child, the user may not have access to certain source devices and or TV channels. On the other hand, based on a user being recognized as elderly, the user may not be allowed to change the picture settings.

While the particular TAILORING AUDIO VIDEO OUTPUT FOR VIEWER POSITION AND NEEDS .is herein shown and described in detail, it is to be understood that the subject matter which is encompassed by the present invention is limited only by the claims.

What is claimed is:

1. Assembly comprising:
video display;
at least one audio speaker;
processor controlling the display and speaker to output audio video (AV) content to a viewer of the assembly; and
camera inputting an image of the viewer to the processor, the processor determining a viewer position including at least an azimuth of the viewer relative to the assembly, the processor adjusting display of at least some of the AV content responsive to the position of the viewer.

2. The assembly of claim 1, wherein the position further includes elevation of the viewer relative to the assembly.

3. The assembly of claim 1, wherein the position further includes range of the viewer relative to the assembly.

4. The assembly of claim 1, wherein the processor alters a volume of audio output by the speaker responsive to the position of the viewer.

5. The assembly of claim 1, wherein the processor changes a direction of audio output by the speaker responsive to the position of the viewer.

6. The assembly of claim 1, wherein the processor alters a color setting of the display responsive to the position of the viewer.

7. The assembly of claim 1, wherein the processor alters a size of an onscreen image responsive to the position of the viewer.

8. The assembly of claim 1, wherein the processor alters the frequency of audio output by the speaker responsive to a physical need of the viewer indicating audible impairment.

9. The assembly of claim 1, wherein the processor alters a volume of audio output by the speaker responsive to a physical need of the viewer indicating audible impairment.

10. The assembly of claim 1, wherein the processor alters a size of an onscreen image responsive to a physical need of the viewer indicating visual impairment.

11. The assembly of claim 1, wherein the processor alters a color setting of the display responsive to a physical need of the viewer.

12. The assembly of claim 1, wherein the processor further correlates the viewer to physical audible and/or visual needs of the viewer, the processor adjusting display of at least some of the AV content responsive to the physical audible and/or visual needs of the viewer.

13. Method comprising:
rceiving viewer location information from a camera, the location information representing a relative position of the viewer with respect to an audio video display apparatus including a video display and at least one audio speaker; and
responsive to the viewer location information, establishing a display parameter of the video display and/or a display parameter of the speaker.

14. The method of claim 13, comprising establishing a display parameter of the video display responsive to the viewer location information.

15. The method of claim 13, comprising establishing a display parameter of the speaker responsive to the viewer location information.

16. The method of claim 15, wherein the display parameter of the speaker is audio beam direction.

17. The method of claim 15, wherein the display parameter of the speaker is audio volume.

18. Assembly comprising:
video display;
at least one audio speaker;
processor controlling the display and speaker to output audio video (AV) content to a viewer of the assembly; and
camera inputting an image of the viewer to the processor, the processor correlating the viewer to physical audible and/or visual needs of the viewer, the processor adjusting display of at least some of the AV content responsive to the physical audible arid/or visual needs of the viewer.

19. The assembly of claim 18, wherein the processor alters a volume of audio output by the speaker responsive to a physical need of the viewer indicating audible impairment.

20. The assembly of claim 18, wherein the processor further determines a viewer position including at least an azimuth of the viewer relative to the assembly, the processor adjusting display of at, least some of the AV content responsive to the position of the viewer.

21. The assembly of claim 18, wherein responsive to determining an identity of a viewer of the assembly, access to a user interface (UI) presented on the display is established and functionality of the UI is limited.
